(19) United States
(12) Patent Application Publication
(10) Pub. No.: US 2015/0125638 A1
(43) Pub. Date: May 7, 2015

(54) MANUFACTURING METHOD FOR GENERALLY CYLINDRICAL THREE-DIMENSIONAL CONFORMAL LINERS

(71) Applicant: ADVANCED TECHNOLOGY MATERIALS, INC., Danbury, CT (US)

(72) Inventors: Royce Richter, Eden Prairie, MN (US); Bradd Donald Nielson, Mound, MN (US); Jacek Katarzynski, Toronto (CA); Edward Brunott, Toronto (CA); Gary Eastwood, Georgetown (CA)

(21) Appl. No.: 14/398,262

(22) PCT Filed: Apr. 30, 2013
(86) PCT No.: PCT/US2013/038872

§ 371 Date: Oct. 31, 2014

Related U.S. Application Data
(60) Provisional application No. 61/641,702, filed on May 2, 2012.
(60) Provisional application No. 61/731,915, filed on Nov. 30, 2012.

(51) Int. Cl. B32B 27/28

(52) U.S. Cl. CPC B32B 27/28
USPC 428/34.1; 156/69

(57) ABSTRACT

A method for manufacturing a liner, the method including forming a tubular body portion having a top circumferential edge, a bottom circumferential edge, and a weld seam or seams extending from the top circumferential edge to the bottom circumferential edge; stretching the tubular body near the top circumferential edge and welding a top liner sheet portion along the stretched top circumferential edge, the top liner sheet portion having a fitment welded thereto; and stretching the tubular body near the bottom circumferential edge and welding a bottom liner sheet portion along the stretched bottom circumferential edge. The weld between the tubular body portion and the top liner sheet portion may be effected with the inner wetted surfaces of each portion in contact. Similarly, the weld between the tubular body portion and the bottom liner sheet portion is effected with the inner wetted surfaces of each portion in contact.

### FIELD OF THE INVENTION

The present disclosure relates to liner-based storage and dispensing systems. Particularly, the present disclosure relates to three-dimensional liners for use with conventional, generally cylindrically-shaped overpacks, whereby the liner is configured to substantially conform to the size and shape of the interior of the overpack. More particularly, the present disclosure relates to manufacturing methods for such generally cylindrical three-dimensional conformal liners.

### BACKGROUND OF THE INVENTION

Numerous manufacturing processes require the use of ultrapure liquids, such as acids, solvents, bases, photoresists, slurries, cleaning formulations, dopants, inorganic, organic, metalorganic and biological solutions, pharmaceuticals, and radioactive chemicals. Such applications require that the number and size of particles in the ultrapure liquids be minimized. In particular, because ultrapure liquids are used in many aspects of the microelectronic manufacturing process, semiconductor manufacturers have established strict particle concentration specifications for process chemicals and chemical-handling equipment. Such specifications are needed because, should the liquids used during the manufacturing process contain high levels of particles, bubbles, metals, and other trace contaminants, the particles, bubbles, or the like may be deposited on solid surfaces of the silicon. This can, in turn, lead to product failure and reduced quality and reliability.

Accordingly, storage, transportation, and dispensing of such ultrapure liquids require containers capable of providing adequate protection for the retained liquids. Collapsible liner-based containers, such as the NOWPak® dispense system marketed by ATMI, Inc., are capable of reducing such air-liquid interfaces by pressurizing, with gas or fluid, onto the liner, as opposed to directly onto the liquid in the container, while dispensing. However, pressure dispense is not traditionally used with certain liner-based systems. For example, liner-based systems that include drum or canister style overpacks often dispense the contents of the liner via pump dispense. Pump dispense systems can be disadvantageous because they can be very expensive and may easily break down.

Thus, there exists a need for three-dimensional liners for use with conventional, generally cylindrically-shaped overpacks, whereby the liner is configured to substantially conform to the size and shape of the interior of the overpack, and which, while not intended as their only use, may be suitable for pressure dispense applications. There is particular need for advantageous manufacturing methods for such generally cylindrical three-dimensional conformal liners, and more particularly, advantageous manufacturing methods for adjoining various components of such liners of the present disclosure, such as for adjoining a tube-shaped body portion, a top portion that includes a fitment, and a bottom portion, the adjoined components defining an enclosed interior for holding a material. Still further, there is a need for advantageous processes for creating a generally cylindrical three-dimensional liner that substantially conforms to the interior of an overpack, has top and bottom portions sealed with a generally circular or circumferential weld to a body portion, a fitment centrally located on the top portion of the liner, and which can meet high standards of cleanliness.

### BRIEF SUMMARY OF THE INVENTION

The present disclosure, in one embodiment, relates to a method for manufacturing a liner. The method may include substantially uniformly stretching a tubular liner body near a circumferential edge and welding a sheet portion along the stretched top circumferential edge.

The present disclosure, in another embodiment, relates to a method for manufacturing a liner. The method may include substantially uniformly stretching a tubular body near a top circumferential edge and welding a top liner sheet portion along the stretched top circumferential edge, the top liner sheet portion having a fitment welded thereto; and substantially uniformly stretching the tubular body near a bottom circumferential edge and welding a bottom liner sheet portion along the stretched bottom circumferential edge.

The present disclosure, in yet another embodiment, relates to a method for manufacturing a liner. The method may include forming a tubular body portion having a top circumferential edge, a bottom circumferential edge, and a weld seam extending from the top circumferential edge to the bottom circumferential edge; stretching the tubular body near the top circumferential edge and welding a top liner sheet portion along the stretched top circumferential edge, the top liner sheet portion having a fitment welded thereto; and stretching the tubular body near the bottom circumferential edge and welding a bottom liner sheet portion along the stretched bottom circumferential edge. The weld between the tubular body portion and the top liner sheet portion may be effected with the inner wetted surfaces of each portion in contact. Similarly, the weld between the tubular body portion and the bottom liner sheet portion is effected with the inner wetted surfaces of each portion in contact. The tubular body portion may be formed from two sheets welded together to form a tubular body, the tubular body portion thus having two weld seams extending from the top circumferential edge to the bottom circumferential edge.

The present disclosure, in still another embodiment, relates to a liner made by the process of forming a tubular body portion having a top circumferential edge, a bottom circumferential edge, and a weld seam extending from the top circumferential edge to the bottom circumferential edge; stretching the tubular body near the top circumferential edge and welding a top liner sheet portion along the stretched top circumferential edge, the top liner sheet portion having a fitment welded thereto; and stretching the tubular body near the bottom circumferential edge and welding a bottom liner sheet portion along the stretched bottom circumferential edge.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a partial cross-sectional isometric view of a liner-based system in accordance with an embodiment of the present disclosure.

FIG. 2 is a schematic of a film composition for a liner in accordance with an embodiment of the present disclosure.

FIG. 3 is an isometric view of a liner in accordance with an embodiment of the present disclosure.

FIG. 4 is a flow diagram for a method of manufacturing a liner in accordance with an embodiment of the present disclosure.

FIGS. 5A and B are schematics of the various components of a liner in accordance with an embodiment of the present disclosure.

FIG. 6 is a side cross-sectional view of a sealer apparatus for use in a method of manufacturing a liner in accordance with an embodiment of the present disclosure.

FIG. 7 is a cross-sectional view of a circumferential edge of a tubular body portion of a liner stretched over a sealing surface readying the circumferential edge for welding in accordance with an embodiment of the present disclosure.

FIGS. 8A-8C are side, cross-sectional views of a tubular body portion of a liner coupled with a stretching apparatus in accordance with an embodiment of the present disclosure.

FIG. 9A is a top view of a stretcher according to an embodiment of the present disclosure illustrating the plates in an unstretched position.

FIG. 9B is a top view of a stretcher according to an embodiment of the present disclosure illustrating the plates in a stretched position.

FIG. 10 includes various schematic illustrations of a stretching apparatus according to another embodiment of the present disclosure.

### DETAILED DESCRIPTION

The present disclosure relates to novel and advantageous three-dimensional liners for use with conventional, generally cylindrically-shaped overpacks, whereby the liner is configured to substantially conform to the size and shape of the interior of the overpack. Particularly, the present disclosure relates to novel and advantageous manufacturing methods for such generally cylindrical three-dimensional conformal liners. More particularly, the present disclosure relates to novel and advantageous manufacturing methods for adjoining various components of such liners of the present disclosure, such as for adjoining a tube-shaped body portion, a top portion that includes a fitment, and a bottom portion, the adjoined components defining an enclosed interior for holding a material. Still further, the present disclosure relates to novel and advantageous processes for creating a generally cylindrical three-dimensional liner that substantially conforms to the interior of an overpack, has top and bottom portions sealed with a generally circular or circumferential weld to a body portion, a fitment centrally located on the top portion of the liner, and which can meet high standards of cleanliness.

Although not limited to such liners, generally cylindrical three-dimensional conformal liners of the present disclosure, in some embodiments, may be liners in accordance with those disclosed in International PCT Application No. PCT/US2011/064141, titled “Generally Cylindrically-Shaped Liner For Use in Pressure Dispense Systems and Methods of Manufacturing the Same,” filed Dec. 9, 2011, the contents of which are hereby incorporated herein by reference in their entirety. The three-dimensional, conformal shape of such liners and/or the properties of the film comprising such liners (including the material used and/or the thickness of the liner) may advantageously provide the liners with desirable characteristics, including but not limited to: increased dispensability; reduction or elimination of fold gas, pinholes, and/or weld tears; and/or a reduction in the load and stress on the liner fitment. Because embodiments of liners of the present disclosure may be used to store, ship, and/or dispense ultrapure, and/or relatively expensive, and in some cases extremely expensive materials, the above-noted advantages may provide significant advantages over conventional liners used with generally cylindrically-shaped overpacks.

For example, uses of such liners may include, but are not limited to, transporting and dispensing ultrapure chemicals and/or materials such as photoresist, bump resist, cleaning solvents, TARC/BARC (Top-Side Anti-Reflective Coating/Bottom-Side Anti-Reflective Coating), low weight ketones and/or copper chemicals for use in such industries as microelectronic manufacturing, semiconductor manufacturing, and flat panel display manufacturing, for example. Additional uses may include, but are not limited to, transporting and dispensing acids, solvents, bases, slurries, cleaning formulations, dopants, inorganics, organics, metalorganics, TEOS, and biological solutions, pharmaceuticals, and radioactive chemicals. However, such liners may further be used in other industries and for transporting and dispensing other products such as, but not limited to, paints, adhesives, soft drinks, cooking oils, agrochemicals, health and oral hygiene products, and toiletry products, etc. Those skilled in the art will recognize the benefits of such liner-based systems and the process of manufacturing the liners, and therefore will recognize the suitability of the liners for use in various industries and for the transportation and dispense of various products.

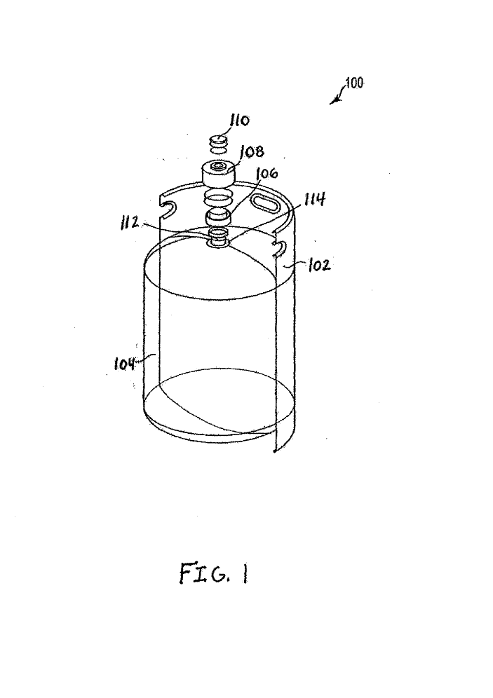

In general, as illustrated in FIG. 1, such liner-based systems 100 may include an overpack 102 and a liner 104. The overpack 102, in some embodiments, may be generally cylindrically-shaped with a hollow interior capable of receiving the liner 104. In some embodiments, the liners 104 of the present disclosure may be configured to be compatible in use with existing overpacks and/or dispensing systems. That is, in some embodiments, the overpack 102 may include traditional overpacks such as existing drums or canisters used for storing and/or dispensing materials, including overpacks with larger mouth openings than that illustrated in FIG. 1 as well as overpacks wherein the entire lid or top opens, for example, and/or overpacks meeting UN DOT certifications for hazardous material. The overpack 102 may be designed to have any suitable shape and/or size; however, in some embodiments, the overpack 102 may have a substantially cylindrical or barrel-like shape of any suitable size, including any suitable circumference and/or height. In some embodiments, for example, the overpack 102 may comprise known drums or canisters of 19 L, 40 L, 200 L sizes, or generally of any size between 1 L and 1000 L. The overpack 102 may be comprised of any suitable substantially rigid material, for example, but not limited to, metal, glass, wood, plastic, composites, corrugated materials, paperboard, or any other suitable material or combination of materials. The overpack 102 may also include a closure and/or connecting assembly, which may include, for example, a fitment retainer 106, a closure 108, and/or a shipping cap 110. In embodiments of the present disclosure that utilize an existing or known overpack 102, the closure and/or connecting assembly that has traditionally been used with such an overpack may be used.

The liner 104 of such liner-based systems 100 may be generally cylindrically-shaped such that in an expanded state, the liner substantially conforms to the shape of the interior cavity of the overpack 102. In a collapsed state, the liner 104 may collapse such that the liner fits through the overpack neck 114. The liner 104 may additionally include a fitment 112. The fitment 112 of the liner 104 may be configured such that when the liner is inserted into the overpack 102, the fitment may nest inside of the fitment retainer 106 and/or the neck 114 of the overpack. In some embodiments, the fitment retainer 106 of the overpack 102 may detachably secure to the fitment 112 of the liner 104 and/or the neck 114 of the overpack, thereby supporting the liner within the overpack. While illustrated as a closed liner, e.g., having top and bottom portions substantially closing the ends of the cylindrically-shaped body, a liner of the present disclosure could also be an open top liner, having simply a bottom portion substantially closing one end of the cylindrically-shaped body.

Because a liner of the present disclosure may be configured to generally or substantially conform to the interior space of the generally cylindrical overpack, increased dispensability of the liner may advantageously be achieved. Further, the shape of the liner of the present disclosure may decrease or eliminate fold gas, pinholes and/or weld tears during transport. Some traditional non-cylindrical liners, for example pillow type liners with a fitment located at the top portion on one side of the liner, may not fully utilize all of the interior space available within an overpack. Furthermore, in contrast to traditional pillow type liners or other less conformal two dimensionally shaped liners, because the liner of the present disclosure may substantially conform to the overall shape of the overpack when the liner is full, the liner may not tend to pull downward and away from the top of the overpack. Instead, the liner may be filled generally to the top of the overpack, with minimal stress on the circumferential top weld or the fitment area. Further, because the liner of the present disclosure in some embodiments may substantially conform to the shape of the overpack, the liner may not generally fold in upon itself, which could otherwise potentially cause the contents of the liner to become trapped. The shape of the liner in some embodiments may thus eliminate or reduce the existence of such folds that can create air or gas pockets that may contaminate the contents of the liner. As such, fold gas (gas that may be trapped in the folds of the liner when the liner is filled) may be decreased in embodiments of the present disclosure versus traditional pillow type liners. The substantially conformal shape of the liner to the overpack may also help support the liner in the headspace region, may decrease the tendency of the liner to fold on itself, and may limit the amount of fluid motion that occurs during shipping and/or transport that could otherwise cause micro folds to flex, and could result in pinholes or weld tears.

As explained above, in some cases, liners may be filled with expensive materials, and in some cases extremely expensive materials. Accordingly, reducing or eliminating the potential for overflow (i.e., losing some of the contents of the liner during filling because the liner cannot accommodate all of the material) may be advantageous. One way to reduce or eliminate the risk of overflow is by increasing the capacity of the liner for holding liquid contents. Liners of the present disclosure, in some embodiments, may have increased content volume relative to other liners designed for holding a similar volume because the amount of volume wasted by excess folds in the liner and trapped gas may be decreased. Accordingly, a conformal liner of the present disclosure configured to hold 200 L may actually accommodate about 2 to 10 more liters of overflow volume compared to traditional liners; in other sizes, a conformal liner of the present disclosure may generally hold about 5% to 10% more overflow volume. Increasing the capacity of the liner may reduce, substantially reduce, or eliminate the risk of overflow for liners of the present disclosure, in some embodiments. The substantially conformal shape of the liner to the overpack may also reduce the load and stress on the fitment and fitment weld of the liner of the present disclosure in some embodiments.

In some embodiments, although not required, the overall thickness of a liner of the present disclosure may be thicker than traditional liners used with drum style overpacks. One advantage of a liner with a thickness greater than traditional liners may be that the increased thickness can help prevent or reduce the occurrence of pin holes (small holes that can form in the liner), fold gas, weld tears, and/or gas diffusion that may occur during filling, storage, shipment, and/or dispense. The increased thickness of the liner may also help prevent choke-off during dispense. While the overall thickness of embodiments of the present disclosure may be greater than that of traditional liners, the thickness may not be so great as to prevent the liner from being inserted into or extracted from the overpack through the neck of the overpack when the liner is in a collapsed state. Accordingly, any suitable thickness of the liner is contemplated by the present disclosure. For example, in some embodiments, the liner may have an overall thickness from about 80 to about 280 microns. In further embodiments, the liner may have an overall thickness from about 100 to about 220 microns. In still other embodiments, the liner may have an overall thickness from about 150 to about 200 microns. In still other embodiments, the liner may have an overall thickness from about 100 to about 150 microns. However, even thicker liners may be used, particularly with overpacks having larger mouth openings than those illustrated as well as overpacks wherein the entire lid or top opens, for example. As used here and throughout the present disclosure, ranges are used as a short hand for describing each and every value that is within the range; any value within the range can be selected as the terminus of the range.

Liners of the present disclosure may be monolayered or may comprise one, two, or more layers made from one or more suitable materials. In some embodiments, for example, the liner may consist of two or more layers, whereby the two or more layers may be made from the same material or may be made from different materials. Each of the one or more layers may have any suitable thickness. In some embodiments with two or more layers, each layer may have the same thickness, while in other embodiments, the two or more layers may have different thicknesses. In some embodiments, the one or more layers of the liner may be free of plasticizers, heat stabilizers, colorants, flame retardants, mold release agents (DMPS) and/or other microelectronic contaminants. In some embodiments, the inner layer of the liner, or in embodiments comprising a single layer, the surface of the layer that makes contact with the contents of the liner may be comprised of a chemically compatible material. For example, the inner or wetted layer may be comprised of, for example, but may not be limited to, linear low-density polyethylene (LLDPE), polyethylene (PE), polytetrafluoroethylene (PTFE), perfluoroalkoxy (PFA), fluorinated ethylene propylene copolymer (FEP), polyethylene naphthalate (PEN), polyethylene terephthalate (PET), polybutylene terephthalate (PBT), or any other suitable material or combination of materials. In some embodiments, the outer or protective layer or layers, may generally consist of a relatively more robust material that may act as a moisture and/or gas barrier to prevent contamination of the contents of the liner through the liner walls. Additionally, the one or more outer layers may have additional properties to ensure that the liner remains intact and resistant to cracks, tears, pin holing or other degradation that may occur during shipping and/or storage. The one or more outer layers may be comprised of, but are not limited to, polyethylene (PE), polybutylene terephthalate (PBT), polyamides (PA), polypropylene (PP), ethylene vinyl alcohol (EVOH), polyethylene naphthalate (PEN), polyethylene terephthalate (PET), or any other suitable material and/or combination of materials.

In some embodiments, the liner may also include any number of additional barrier layers that may be positioned between an inner layer and one or more outer layers. An additional barrier layer or layers may help keep the contents of the liner from seeping out of the liner as well as help keep gas and/or other contaminants from seeping into the interior of the liner. The barrier layers, in some embodiments, may be comprised of, for example ethylene-vinyl alcohol copolymer (EVOH), nylon or any other suitable material or combination of materials, such as any of those materials identified above.

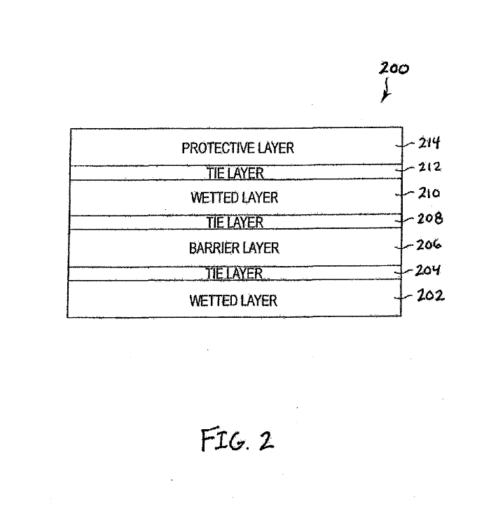

Embodiments of the liner of the present disclosure that include two or more layers may be configured such that the layers may be arranged in any suitable order and/or combination. For example, as may be seen in FIG. 2, which shows a cross-section of a multi-layer liner 200, in one embodiment, a liner may include an inner surface or wetted layer 202, a barrier layer 206, an inner layer 210 (which in some embodiments, may be of similar or same composition to the wetted layer 202), and a protective or outer layer 214. Any two layers may have one or more tie layer 204, 208, 212 between them. While FIG. 2 shows one configuration of possible layers of a multi-layer liner, it will be understood that any other suitable combination of layers is within the spirit and scope of the present disclosure. For example, in one embodiment, a liner may include an inner surface or wetted layer 202, a barrier layer 206, and an inner layer 210 (which may be the outer layer), with potentially one or more tie layers 204, 208 between them. As discussed above, each of the layers of a multi-layer liner 200 may have any suitable thickness that may or may not be the same thickness as the other layers of the liner. In some embodiments, the thickness of one or more of the non-tie layers may be from about 5 to about 140 microns. In further embodiments, the thickness of one or more of the non-tie layers may be from about 10 to about 120 microns. In still further embodiments, the thickness of the one or more of the non-tie layers may be from about 15 to about 100 microns. It will be understood, however, that the one or more layers of a multi-layer liner may have any suitable thickness. The film comprising the liner of the present disclosure may be formed by any suitable process or combination of processes. For example, the film for the liner may be formed by co-extrusion, extrusion blow molding, injection blow molding, injection stretch blow molding, from blown and/or cast film, or any other suitable method or combination of methods.

In general, however, the film comprising the liner of the present disclosure may have any structure, composition, thickness, modulus, break strength, etc. suitable, but not limited to, for containing the type of materials listed herein and suitable for application of the methods described herein. For example, in many embodiments, the film should have a sufficient thickness and composition to support the stored material and dispense application desired. However, the film, in many embodiments, should not be so thick as to preclude, or made of a composition precluding, the film from having a desirable amount of stretchability to accommodate the methods described herein without tearing. In further embodiments, the structure, composition, thickness, modulus, break strength, etc. may also be selected such that the film has a reduced or minimal amount of permanent deformation.

Traditionally, the contents of liners for use with drum style overpacks are dispensed by pump dispense. Accordingly, typically a dip tube may be used in conjunction with the liner and overpack in order to pump the contents out of the liner, including by using existing pump dispense systems adapted for a dip tube. However, pump dispense may generally fail to consistently achieve as high a rate of dispense as other dispense methods, for example pressure dispense. Further, the dip tube used during pump dispense can be relatively expensive, particularly as the dip tube is typically disposed of after a single use. Advantageously, the contents of the liners of the present disclosure in some embodiments may be dispensed by pressure dispense without the use of a dip tube. As such, the dispensability of some embodiments of liners of the present disclosure may be higher, and the overall cost of the system may be less than that of known liners used with pump dispense. In some particular embodiments, liner-based systems of the present disclosure may be configured such that they are compatible with the NOWPak® pressure dispense system, such as that disclosed in U.S. patent application Ser. No. 11/915,996, titled “Fluid Storage and Dispensing Systems and Processes,” which was filed Jun. 5, 2006, the contents of which are hereby incorporated herein by reference in their entirety. Similarly, a sample of a misconnect prevention connector that may be used with the liner-based system of the present disclosure may be that of ATMI of Danbury, Conn., or those disclosed in U.S. Patent Application No. 60/813,083 filed on Jun. 13, 2006; U.S. Patent Application No. 60/829,623 filed on Oct. 16, 2006; and U.S. Patent Application No. 60/887,194 filed on Jan. 30, 2007, the contents of which are hereby incorporated herein by reference in their entirety.

While some embodiments of the present disclosure have been described as not having a dip tube, it will be recognized that some embodiments of the present disclosure may nonetheless include a dip tube, including a dip tube of any length from, for example, a full length dip tube, e.g., a dip tube that extends generally all the way to the bottom of the liner, to a small tube that extends from the fitment and/or connector into the interior of the liner a relatively short distance so that the contents of the liner may be directed out of the fitment of the liner. An apparatus of the short dip tube, in some cases, may be referred to as a “stubby probe,” examples of which are described in detail in U.S. patent application Ser. No. 11/915,996, the contents of which were previously incorporated herein by reference in their entirety. In general, the liners of the present disclosure may be utilized with any suitable dispense system and the contents therein may be emptied utilizing any suitable dispense method, such as but not limited to, pump dispense, pressure-assisted pump dispense, direct pressure dispense, indirect pressure dispense, and/or gravity dispense.

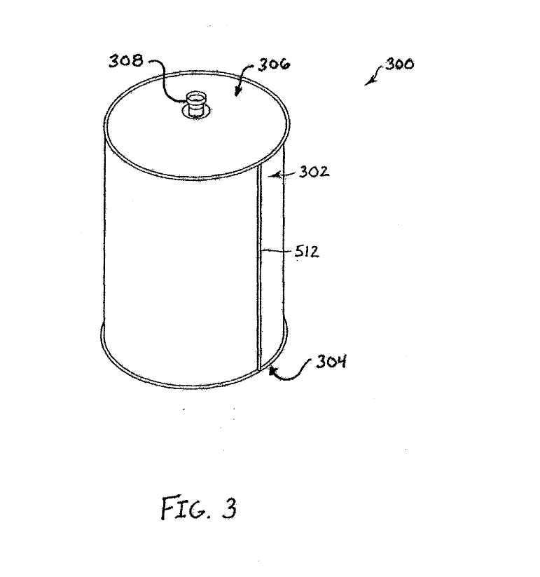

With reference now to FIG. 3, a liner 300 according to some embodiments of the present disclosure may comprise a body portion 302, a bottom portion 304, a top portion 306, and at least one fitment 308. The liner 300 may be a generally closed liner, in that the liner may comprise an interior space for holding a material that may be filled through or dispensed from the fitment 308. However, as mentioned above, the liner 300 may also be an open liner, such that at least one end of the body portion 302 is open, for example, by not having a top portion 306.

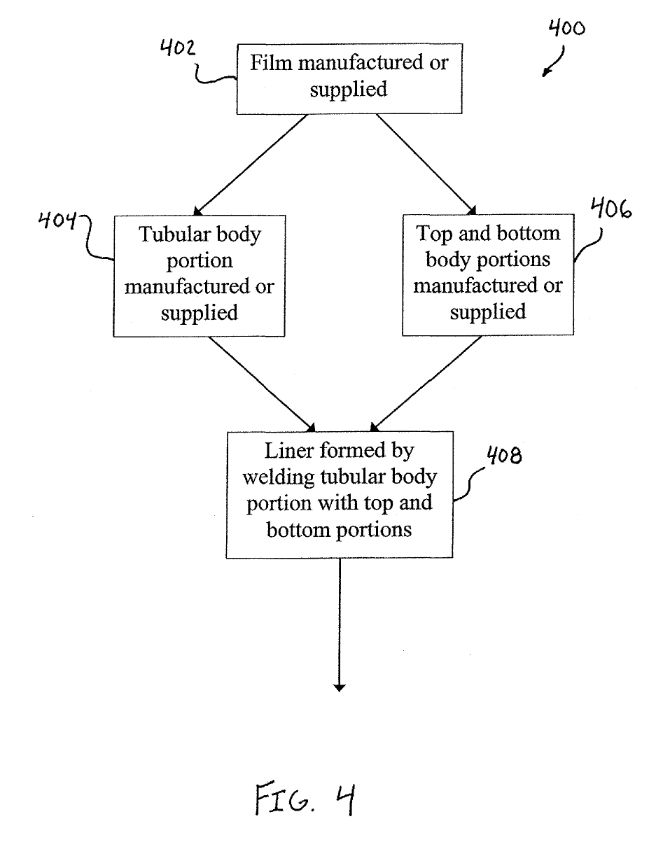

One embodiment of a method 400 for manufacturing a liner 300 in accordance with the present disclosure is illustrated in the flow diagram of FIG. 4. In a first step 402, in accordance with the method 400, a film, having the desired composition and characteristics, may be manufactured, or otherwise supplied. The obtained film may be manufactured using any suitable process, and in one embodiment, may be supplied in sheet form, which can be laid generally flat.

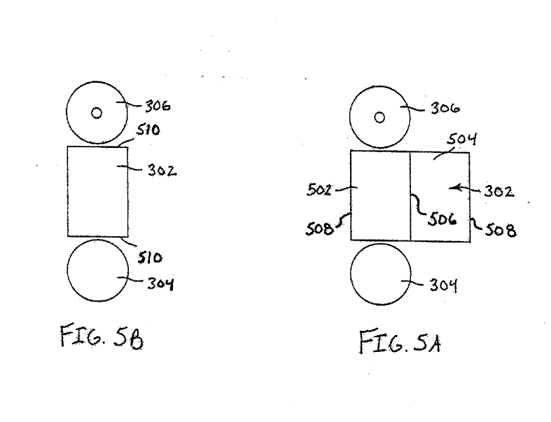

The film can be formed or patterned into the various separate liner components—e.g., body portion 302, bottom portion 304, top portion 306—of the liner 300. In one embodiment, therefore, in a step 404, a portion of the supplied film can be patterned into appropriately sized sheets for forming the body portion. As will be recognized from FIG. 3, for example, the body portion 302 may be generally tube-shaped with two open ends, whereat the bottom 304 and top 306 portions are attached. As illustrated in FIG. 5A, in one embodiment, the tubular body portion 302 may be formed from two or more initially flat, rectangular sheets 502, 504. The two or more rectangular sheets may be welded together along vertical or lengthwise edges 506, 508, as would be understood by those skilled in the art, to form a tube with two open ends defined by circumferential edges 510 of the tube, as illustrated in FIG. 5B. In forming the tubular configuration, vertical weld seams 512 may be formed in the body portion 302, as illustrated in FIG. 3. In the embodiment illustrated, the liner 300 is comprised of two body sheets having two vertical weld seams 512; however more than two body sheets may be utilized, resulting in a corresponding number of vertical weld seams. The vertical weld seams may extend the full length (or height, if you will) of the resulting tubular body portion 302. However, the body portion 302 in some embodiments may alternatively be manufactured or provided directly in tubular form, such as an extruded tubular form, and need not be manufactured from one or more flat sheets.

Similarly, in a step 406, a portion of the supplied film can be patterned into appropriately sized sheets for forming corresponding bottom 304 and top 306 portions. As may be recognized in FIG. 3 (but which may also be seen in FIG. 5), the bottom 304 and top 306 portions may each ultimately be generally circular in shape and sized to substantially match or substantially correspond to the diameter of the open ends of the formed body portion 302. While the bottom 304 and top 306 portions may be initially patterned from the supplied film in generally circular shapes, in one embodiment, the supplied film may be patterned into square or rectangular patterns each appropriately sized to accommodate the desired diameter of bottom 304 and top 306 portions, and from which subsequent cutting and creation of the generally circular bottom 304 and top 306 portions can be performed. Of course in other embodiments, the supplied film may be suitably patterned into any other regular or irregular shape from which a subsequent generally circular shape may be cut or created. In this regard, the patterned film pieces should be sized to accommodate the desired diameter of bottom 304 and top 306 portions.

In additional embodiments, the subset of patterned sheets designated for forming the top portions 306 may be subjected to a fitment fitting process. In this regard, non-film components, such as but not limited to, fitment 112, for the liner may also be supplied to the process 400. The various components may be manufactured using any suitable process and materials, and are further described in International PCT Application No. PCT/US2011/064141, which was previously incorporated herein. For example, the fitment 112 may be comprised of any suitable material or combination of materials, such as but not limited to, a suitably rigid plastic such as high density polyethylene (HDPE). In some embodiments, the fitment 112 may be comprised of a more rigid material than the film of the liner 300. The fitment 112 may be sized and shaped such that the fitment may be positioned inside of the fitment retainer 106 and/or the neck 114 of the overpack and/or be compatible with some or all components of the closure and/or connector assembly of the overpack. In further embodiments, the fitment 112 may be sized and shaped to be compatible with the closure and/or connector assembly of a particular known overpack or overpack type. Such known overpacks may be compatible, for example, with a liner fitment 112 having a ¾ inch to a 2 inch diameter, for example. It will be understood, however, that the liner fitment 112 may have any suitable diameter and/or shape and size such that it is compatible with a desired overpack.

As a part of step 406, a fitment 112 may be attached to each patterned sheet designated for forming a top portion 306. According to one embodiment, in each of the top portion sheets, a hole may be cut or otherwise formed where the fitment is to be positioned. In one embodiment, the fitment may be positioned generally at a central axis of the patterned sheet, such that the fitment will be positioned substantially centrally along a vertical axis of the resulting liner 300; however, central location of the fitment is not required, and any other suitable position may be used, as desired. With the hole formed and the fitment 112 correspondingly aligned, the fitment, in some embodiments, may be securely sealed to the liner via welding or any other suitable method or combination of methods, such as by utilizing adhesives or other bonding agents.

While a method of forming the separate liner components—e.g., body portion 302, bottom portion 304, top portion 306—has been described, in other embodiments, the separate liner components could of course be provided to the methods described herein pre-manufactured or pre-formed in the desired configuration, ready for assembly as will be described in further detail below. Once the various separate liner components—body portion 302, bottom portion 304, top portion 306—are obtained or formed, as described above, the bottom and top portions may be sealed to the body portion in a step 408. The bottom 304 and top 306 portions may be sealed to the tubular body portion 302 via welding or any other suitable method. Furthermore, as mentioned above, in other embodiments, a liner of the present disclosure may be an open liner, such that only a bottom 304 portion, for example, is sealed to the tubular body portion 302.

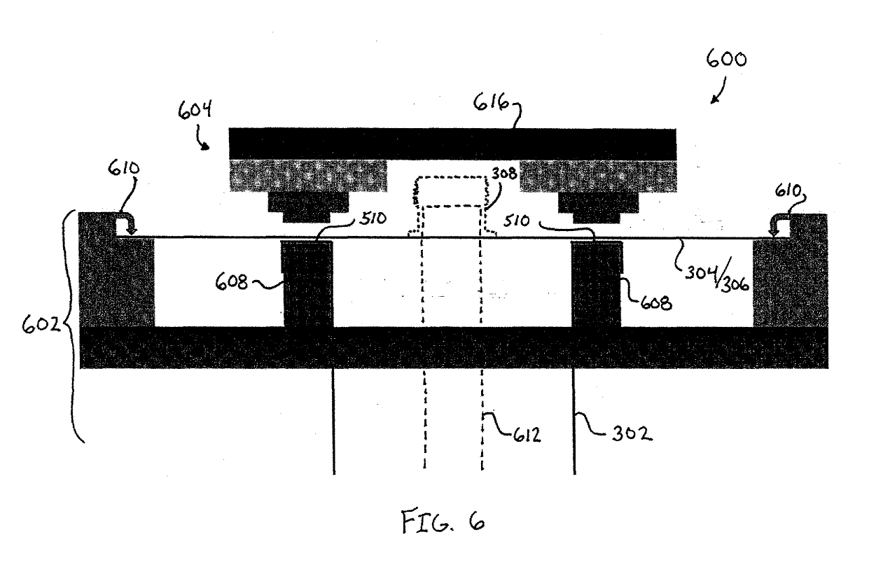

One embodiment of an apparatus or sealer 600 for efficient, consistent, and relatively or substantially clean sealing of bottom 304 and top 306 portions to a tubular body portion 302, and which may be utilized for at least part of step 408, is illustrated in FIG. 6. Sealer 600 may have at least one liner load/unload station 602 and a liner weld station 604. A load/unload station 602 may have a sealing surface 608, which may be in the shape of a ring in some embodiments, over which a circumferential edge 510 of one end of the tubular body portion may be positioned, as will be described in further detail below, for accurate sealing with a bottom 304 or top 306 portion in the weld station 604. The load/unload station 602 may also include one or more means for positioning and stabilizing 610 a bottom 304 or top 306 portion, whichever the case may be, over the sealing surface. In one embodiment, the means for stabilizing 610 the bottom or top portion may include one or more grips, clamps, vises, etc. to which the bottom or top portion may be coupled and held or stretched relatively firmly in position for welding. The sealing surface 608 may be adjustable to other sizes, or may be replaceable with a sealing surface of another size, in order to accommodate the manufacture of varying diameters of liners, as may be desired. The sealing surface, or a top portion thereof, could be made of any suitable material, including but not limited to, rubber or any Teflon coated material.

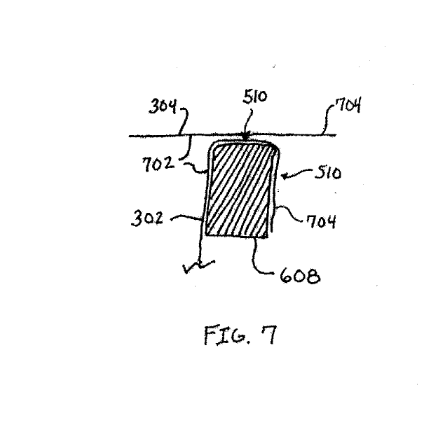

In order to seal a top portion 306 to a tubular body portion 302, the tubular body portion may be inserted on an interior side of the sealing surface 608 and a specified or predetermined amount of the circumferential edge 510 of a first end of the tubular body may be pulled, wrapped, stretched, or the like, over or around the sealing surface. A close-up, cross-sectional view of a circumferential edge 510 stretched over the sealing surface 608 is illustrated in FIG. 7. It is recognized, however, that the tubular body portion 302, in other embodiments, may be applied around an exterior side of the sealing surface 608 and a specified or predetermined amount of the circumferential edge 510 of a first end of the tubular body may be pulled, wrapped, stretched, or the like, inward and over the sealing surface. In some embodiments, the circumferential edge 510 may be stretched over the sealing surface manually, such as by hand. However, manual stretching of the circumferential edge 510 over the sealing surface could result in inconsistent sealing, insufficient sealing, and/or defective sealing, typically including a significant amount of wrinkles in the liner weld surface.

Accordingly, in some embodiments, an additional automatic or semi-automatic apparatus may be used to position the circumferential edge 510 over the sealing surface 608. In some embodiments, the additional apparatus may be integral with or attached to the sealer 600. However, in other embodiments, the sealing surface 608 could be removably coupleable with the load/unload station 602 and may be removed and taken to the additional apparatus to which the tubular body portion 302 can be attached and automatically or semi-automatically stretched over the sealing surface.

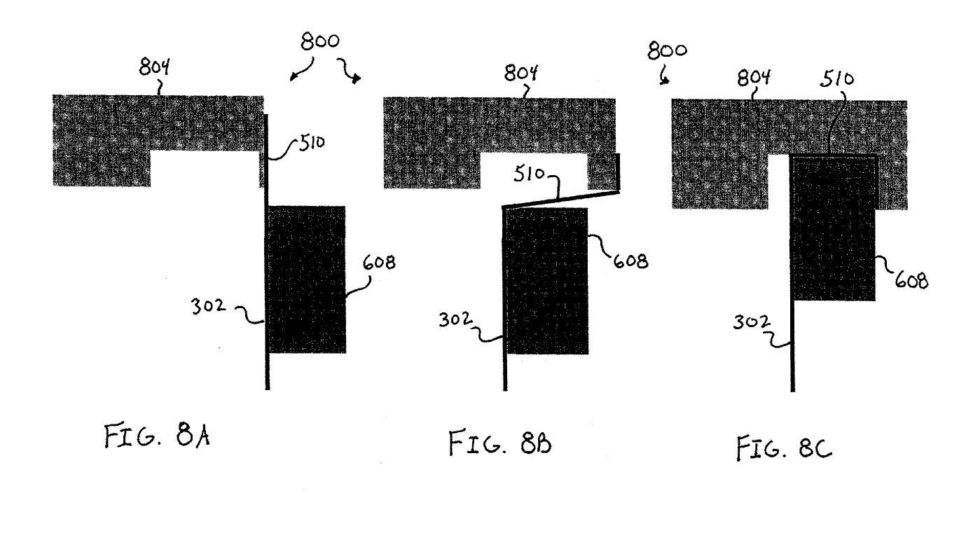

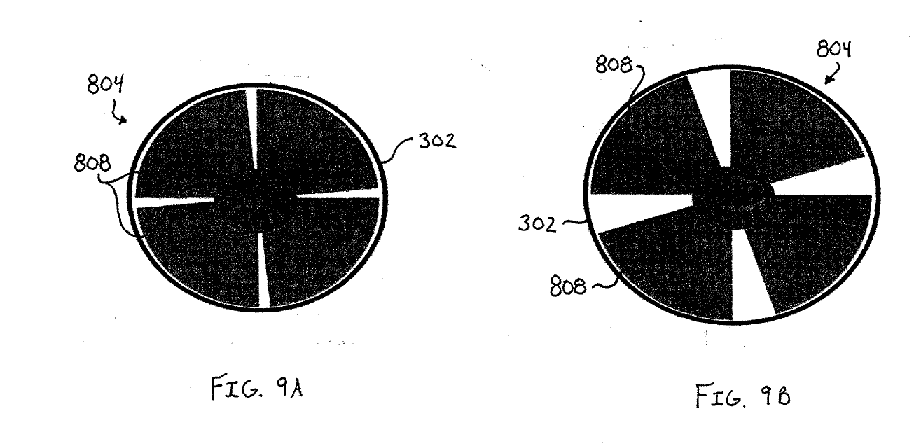

Such a stretching apparatus 800, as illustrated in cross-section in FIGS. 8A-8C, may include means for supporting or holding the sealing surface 608 in position while the circumferential edge 510 of the tubular body portion is stretched over it. The stretching apparatus 800 may also include a circular or cylindrical stretcher 804 to which the tubular body portion 302 may be circumferentially attached using any suitable means of attachment, such as but not limited to, grips, clamps, vises, etc. The circular stretcher 804 may be operable between an unstretched position, illustrated in FIG. 8A, in which the circumferential edge 510 may be operatively coupled therewith, and a stretched position, illustrated in FIG. 8B, in which the coupled circumferential edge is stretched to a desired amount in order to ready it for positioning over the sealing surface 608. In a stretched position, the circular stretcher 804 may expand to a larger diameter than when the circular stretcher is in the unstretched position. While any method of expanding the circular stretcher 804 may be used, in one example embodiment, illustrated in FIGS. 9A and 9B, the expanding circular stretcher may comprise of two, three, four, or more moveable sections 808, which in the case of a circular stretcher may be in the form of arced or semi-circular plates. However, in other embodiments, where the stretcher may be configured for another shaped liner, such as that having a rectangular, square, or triangular tubular body cross-section, the moveable sections may be in a form other than arced or semi-circular plates, such as but not limited to, linear plates, cornered plates, etc. The semi-circular plates, or moveable sections 808, may align with one another to form or approximate a full circle. As discussed above, the circular stretcher 804 may initially begin in an unstretched position, as illustrated in FIG. 9A, wherein the semi-circular plates, or moveable sections 808, are relatively nearer each other. To expand to the stretched position, as discussed with respect to FIG. 8B, one or more of the semi-circular plates, or moveable sections 808, may be moved in a radially outward direction, thereby enlarging the approximated circle defined by the circular stretcher 804, as illustrated in FIG. 9B. In doing so, the diameter of the circumferential edge 510 of the tubular body portion 302, which is removably coupled with semi-circular plates, or moveable sections 808, may also be expanded, and may generally be expanded to slightly larger than the diameter of the sealing surface 608.

In an example process, the sealing surface 608 may be removably coupled with the stretching apparatus 800. In this regard, the tubular body portion 302 may be fed within the sealing surface 608 and a circumferential edge 510 may be coupled with the circular stretcher 804, as discussed above, at one or more areas radially thereabout when the circular stretcher is in an unstretched position, as illustrated in FIGS. 8A and 9A. Although not limited to such an embodiment, the circular stretcher 804, and thus the circumferential edge 510 coupled therewith, may initially begin at a position vertically above the sealing surface 608, as illustrated. Once the circumferential edge 510 is securely or otherwise appropriately coupled with the circular stretcher 804, the circular stretcher may be operated by mechanical or automatic means to expand to the stretched position, where the diameter of the circular stretcher, and thus the diameter of the opening defined by the circumferential edge may also be expanded, as illustrated in FIGS. 8B and 9B. As generally described above, expanding the circular stretcher, in one embodiment, may be accomplished using two, three, four, or more arced or semi-circular plates 808, as illustrated in FIGS. 9A and 9B; however, any method of expanding the circular stretcher may be used. The circumferential edge 510 may generally be stretched by the circular stretcher 804 such that the circumferential edge is enlarged to a diameter larger than the diameter of the sealing surface 608. In this expanded position, the circular stretcher 804, with circumferential edge 510 coupled thereto and stretched to a larger diameter, may be lowered down over and/or past the sealing surface 608, such that the stretched circumferential edge is laid upon and stretched over the sealing surface, extending from an inner circumference of the sealing surface to and over an outer circumference of the sealing surface, as illustrated in FIG. 8C. So positioned, the circular stretcher 804 may release the circumferential edge 510, or the circumferential edge may be decoupled from the circular stretcher, and the circular stretcher can be raised away from the sealing surface, leaving the circumferential edge stretched thereover. The sealing surface 608, with the circumferential edge 510 stretched thereover, may then be uncoupled from the stretching apparatus 800 and brought back to, and recoupled with, the load/unload station 602.

Stretching the circumferential edge 510 of the tubular body over the sealing surface 608 using such automatic or semi-automatic means can be advantageous in that such means can assist in the efficient and consistent creation of highly sufficient seals. Specifically, such automatic or semi-automatic means, such as the stretching apparatus 800, permit generally consistent pressure and stretching applied to the circumferential edge 510 as it is stretched over the sealing surface. The consistent pressure may assist in the creation of a substantially evenly stretched surface of the tubular body portion 302 that is applied over the sealing surface 608, thus providing a generally more consistently flat sealing surface to which a bottom 304 or top 306 portion can be welded. That is, such automatic or semi-automatic means, such as the stretching apparatus 800, may result in reduced or eliminated wrinkles on the liner weld surface where the circumferential edge 510 of the tubular body portion 302 is wrapped or stretched over the sealing surface 608. Additionally, the use of such automatic or semi-automatic means can assist in the creation of more consistently sized and shaped liners than if the stretching were done manually by hand.

The stretch tension of the liner at or near the circumferential edge 510 can be measured and may be identified and set as a stretching endpoint determinate for any given liner embodiment, and in some cases, may also be a function of the film type/composition, the number of film layers, the thickness of the film, or other film characteristics. Polymer deformation, the elastic modulus, and/or the change in morphology in the film may additionally or alternatively be measured and used for identifying and setting the determinate amount of stretch at or near the circumferential edge. In one embodiment, the stretch tension may be monitored and/or measured by the stretching apparatus or one or more additional sensors positioned and aligned for taking such measurements. Additionally or alternatively, an amount of force applied by the stretching apparatus may be monitored and/or measured, and the monitored and/or measured force may be used to determine a stretching endpoint for any given liner embodiment. Still further, in some embodiments, a hard mechanical stop may be used to identify the amount of stretch the stretching apparatus may apply to any given liner embodiment. It is recognized, however, that any suitable method for determining an end stretching point for any given liner embodiment may be utilized.

Additionally, while discussed with respect to a circular or ring sealing surface, it is of course recognized that any other suitable support surface having any desired shape may be utilized and may depend on, for example, the resulting, size, volume, and/or shape of the liner desired. It is recognized that the stretching methods disclosed herein are equally applicable and modifiable for performing other shaped welds, including but not limited to, square, rectangular, triangular, polygonal, or irregular shaped welds.

With the circumferential edge 510 of the tubular body portion 302 stretched over the sealing surface 608, and with the sealing surface recoupled with the load/unload station 602, the top portion 306 may be aligned over the sealing surface and held in position using the means for stabilizing 610, which as described above, may include one or more grips, clamps, vises, or the like. In some embodiments, the top portion 306 may additionally be stretched utilizing, for example, the means for stabilizing, described above, to further assist in reducing or eliminating wrinkle formation in the desired sealing area of the liner. In still other embodiments, the circumferential edge of the tubular body portion may not be stretched, or may not be stretched using automated or semi-automated means as described above, and could merely be laid over the sealing surface. In such embodiments, the top portion 306 may nonetheless be stretched to help reduce wrinkle formation in the desired sealing area. The top portion 306 may be stretched to a measurable tension, and may be determined utilizing any of the methods described above for determining the stretching endpoint for the circumferential edge 510 of the tubular body portion 302, including but not limited to, monitoring and/or measuring the stretch tension, monitoring and/or measuring the amount of force applied by the stretching apparatus, and/or by using a hard mechanical stop. It is recognized, however, that any suitable method for determining an end stretching point for the top portion 306 may be utilized. The amount of stretch applied to the top portion 306 may also be a factor in how much the top portion 306 of the completed liner can dome (see FIG. 1) when filled. Accordingly, the stretch tension can also be used to set the amount of doming of the top portion 306 desired.

The top portion 306 may be aligned over the sealing surface 608 such that the fitment 308 (illustrated in dashed line) is centrally positioned along a central axis of the tubular body portion 302. However, as noted above, central location of the fitment 308 is not required. In a further embodiment, the sealer 600 may include a fitment alignment mechanism 612 (illustrated in dashed line) for assisting in the alignment of the top portion 306 and fitment 308 with respect to the tubular body portion 302. The alignment mechanism 612, in one embodiment, may comprise an alignment rod to which the fitment can be aligned. The alignment rod may be removably coupled to the load/unload station 602 in a position corresponding to the desired fitment position. Once the top portion 306 is sealed to the body portion 302, the alignment rod can be removed for sealing the bottom portion 304, as described below.

With the circumferential edge 510 of the tubular body portion 302 stretched over the sealing surface 608 and the top portion 306 appropriately aligned over the sealing surface and held in position using the means for stabilizing 610, the tubular body portion with the top portion aligned over the sealing surface may be moved from the load/unload station 602 to the liner weld station 604. Of course, in some embodiments, such as illustrated in FIG. 6, the load/unload station 602 and the liner weld station 604 may be located in the generally the same location, and there may be no need to move the tubular body portion 302 and aligned top portion 306 from one to the other. However, in other embodiments, the load/unload station 602 and liner weld station 604 may not necessarily be located at the same position, and it may be necessary to move the tubular body portion 302 and aligned top portion 306, or the load/unload station 602 (or portion thereof) with the tubular body portion 302 and aligned top portion 306 attached thereto, over to the liner weld station 604. At the liner weld station 604, welding of the top portion 306 to the circumferential edge 510 of the tubular body portion 302 along the sealing surface 608 may take place in a conventional manner, such as by a heat welding press 616.

With reference back to FIG. 7, which illustrates a close-up, cross-sectional view of a circumferential edge 510 stretched over the sealing surface 608, welding of a bottom 304 or top 306 portion to the circumferential edge 510 along the sealing surface 608, in the manner described, may generally create a welded seam around the circumference of the body portion 302 where the circumferential edge meets the bottom or top portion. If done in the manner described, a weld may be effected between the inner wetted surfaces 702 of the body portion 302 and the bottom 304 or top 306 portion. Additionally, any excess material 704 remaining in the area on the side of the weld nearest the edges of the body portion 302 and bottom 304 or top 306 portions lies on an external side of the liner. While not limited to this type of weld, such a weld can help increase cleanliness of the liner by ensuring that the adjoining materials are welded at inner wetted surfaces and reducing the amount of excess material on the interior side of the liner. Upon completion of welding the top portion 306 to the circumferential edge 510 of the tubular body portion 302, the adjoined top and tubular body portions may be moved out of the liner weld station 604 back to a load/unload station 602, where the adjoined top and tubular body portions can be removed. In other embodiments, the adjoined top 306 and tubular body 302 portions may be removed directly from the weld station 604.

Very similar steps may be completed to seal a bottom portion 304 to a tubular body portion 302. In one embodiment, the bottom portion 304 may be sealed to the body portion 302 subsequent the top portion 306 to accommodate for placement of the fitment in the top portion. In general, the tubular body portion 302 may be inserted on an interior side of the sealing surface 608. Where the bottom portion 304 does not similarly need to accommodate a fitment, the fitment alignment mechanism 612 may be removed from the load/unload station 602 prior to insertion of the body portion 302. A specified or predetermined amount of the circumferential edge 510 of a second end of the tubular body may be pulled, wrapped, stretched, or the like, over or around the sealing surface. As described above, a stretching apparatus 800 may be used to automate or semi-automate the stretching of the circumferential edge 510 over the sealing surface 608 for efficient, consistent, and/or sufficient sealing.

With the circumferential edge 510 of the tubular body portion 302 stretched over the sealing surface 608, and with the sealing surface coupled with the load/unload station 602, the bottom portion 304 may be aligned over the sealing surface and held in position using the means for stabilizing 610, which as described above, may include one or more grips, clamps, vises, or the like. Similar as above, in some embodiments, the bottom portion 304 may additionally be stretched utilizing, for example, the means for stabilizing, described above, to further assist in reducing or eliminating wrinkle formation in the desired sealing area of the liner. In still other embodiments, the circumferential edge of the tubular body portion may not be stretched, or may not be stretched using automated or semi-automated means as described above, and could merely be laid over the sealing surface. In such embodiments, the bottom portion 304 may nonetheless be stretched to help reduce wrinkle formation in the desired sealing area. The bottom portion 304 may be stretched to a measurable tension, and may be determined utilizing any of the methods described above for determining the stretching endpoint for the circumferential edge 510 of the tubular body portion 302, including but not limited to, monitoring and/or measuring the stretch tension, monitoring and/or measuring the amount of force applied by the stretching apparatus, and/or by using a hard mechanical stop. It is recognized, however, that any suitable method for determining an end stretching point for the bottom portion 304 may be utilized. The amount of stretch applied to the bottom portion 304 may also be a factor in how much the bottom portion 304 of the completed liner can dome (see FIG. 1) when filled. Accordingly, the stretch tension can also be used to set the amount of doming of the bottom portion 304 desired.

With the circumferential edge 510 of the tubular body portion 302 stretched over the sealing surface 608 and the bottom portion 304 appropriately aligned over the sealing surface and held in position using the means for stabilizing 610, the tubular body portion with the bottom portion aligned over the sealing surface may be moved from the load/unload station 602 to the liner weld station 604. Again, in some embodiments, such as illustrated in FIG. 6, the load/unload station 602 and the liner weld station 604 may be located in the generally the same location, and there may be no need to move the tubular body portion 302 and aligned bottom portion 304 from one to the other. However, in other embodiments, the load/unload station 602 and liner weld station 604 may not necessarily be located at the same position, and it may be necessary to move the tubular body portion 302 and aligned bottom portion 304, or the load/unload station 602 (or portion thereof) with the tubular body portion 302 and aligned bottom portion 304 attached thereto, over to the liner weld station 604. At the liner weld station 604, welding of the bottom portion 304 to the circumferential edge 510 of the tubular body portion 302 along the sealing surface 608 may take place in a conventional manner, such as by a heat welding press 616. Upon completion of welding the bottom portion 304 to the circumferential edge 510 of the tubular body portion 302, the adjoined bottom and tubular body portions may be moved out of the liner weld station 604 back to a load/unload station 602, where the adjoined bottom and tubular body portions can be removed. In other embodiments, the adjoined bottom 304 and tubular body 302 portions may be removed directly from the weld station 604. In some embodiments, this may complete the liner welding process. Likewise, in embodiments where an open liner is desired, just the steps for adjoining the bottom 304 and tubular body 302 portions may be utilized, without further adjoining a top portion.

While described above with respect to the formation of a generally cylindrical liner of the type illustrated and the sealing of top and bottom liner portions to a tubular body portion, it is appreciated that the methods of the present disclosure have application in the welding/sealing of any welding configuration. Specifically, the methods of stretching at least one material portion, as described herein, in preparation for, or during, the welding or sealing process of two or more material portions can be utilized for the manufacture of any suitable item and is not limited solely to use during the formation of a generally cylindrical liner of the type illustrated. For example, in some embodiments, a first tubular body portion, such as but not limited to tubular body portion 302, may be circumferentially sealed to a second tubular body portion by applying the above welding methods. Specifically, a circumferential edge of the first tubular body portion may be stretched as described herein, and a circumferential edge of the second tubular body portion may be welded thereto. In some embodiments, the circumferential edge of the second tubular body portion may also be stretched before welding. A bottom and/or top portion, such as but not limited to, bottom and top portions 304, 306, may be welded to one or more of the open circumferential edges of the resulting tube-to-tube structure.

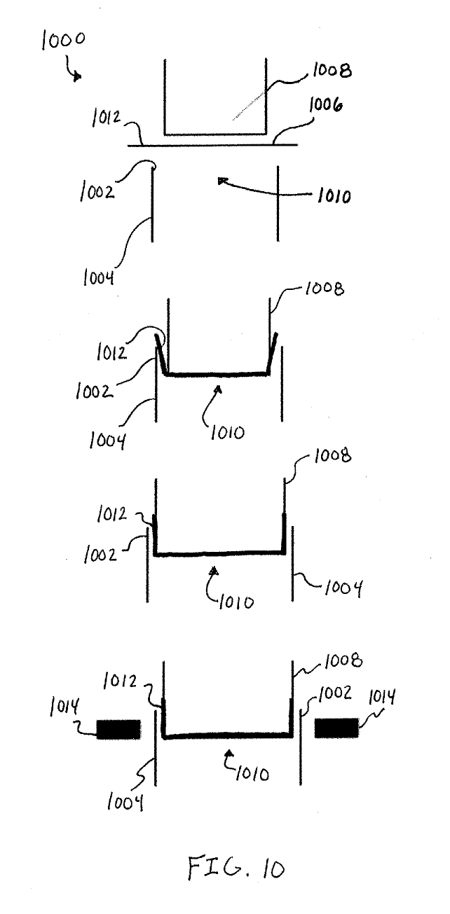

Other similar apparatus and methods may be used to stretch, and in some embodiments, substantially evenly or uniformly stretch, a circumferential edge of a liner material, such that another material can be welded along the circumferential edge, and are considered within the scope of the present disclosure. For example, in an additional embodiment illustrated relatively simply in schematic form in FIG. 10, a stretching apparatus 1000, may include means for supporting or holding the circumferential edge 1002 of a tubular body 1004, such as edge 510 of the tubular body portion, in a circumferentially expanded formation, illustrated in cross-section in FIG. 10. In addition, the stretching apparatus 1000 may include means for supporting or holding a relatively flat portion of supplied film 1006, such as bottom 304 and top 306 portions, in a substantially horizontal position over, or substantially perpendicular position with respect to, the tubular body 1004, as illustrated in the top picture in FIG. 10. The means for supporting or holding the tubular body 1004 and/or the film 1006 may include any suitable means of attachment, such as but not limited to, grips, clamps, vises, etc. The stretching apparatus 1000 may include a circular or cylindrically shaped stretcher 1008, which may have an initial starting position generally above the supplied film 1006, or otherwise on the opposite side of supplied film 1006 from the tubular body 1004. The stretcher 1008 may be sized and shaped to generally fit within an opening 1010 of the circumferentially expanded tubular body 1004. In general, the circular stretcher 1008 may be operable between an initial position, illustrated at the top of FIG. 10, in which the stretcher is not performing any stretching of material, and a stretched position, illustrated in the second and third pictures from the top in FIG. 10, in which the stretcher is pressed into and contacts the supplied film 1006, thereby stretching a circumferential edge 1012 of the supplied film down and into the opening 1010 of the circumferentially expanded tubular body 1004. In alternative embodiments, the supplied film 1006 may be stretched onto the stretcher 1008 prior to positioning the stretcher, with supplied film attached, into the opening 1010. The circumferential edge 1012 is stretched to a desired amount in order to ready it for sealing with circumferential edge 1002 of tubular body 1004, such as edge 510 of the tubular body portion described above. In such an embodiment, the circular stretcher 1008 need not expand, but only moves in a predetermined manner so as to stretch circumferential edge 1012 of the supplied film down and into the opening 1010. While any suitable mechanism may be used as the stretcher 1008, in one example embodiment, illustrated in FIG. 10, the circular stretcher may comprise a press or piston having a generally circular head. However, in other embodiments, where the stretcher may be configured for another shaped liner, such as that having a rectangular, square, or triangular tubular body cross-section, the head may be in a form other than circular, such as but not limited to, square-shaped or rectangular, etc.

Stretching of circumferential edge 1012 of the supplied film 1006 using stretcher 1008 may be done using automatic or semi-automatic means, which can be advantageous in that such means can assist in the efficient and consistent creation of highly sufficient seals. As described above, such automatic or semi-automatic means, such as the stretching apparatus 1000, permit generally consistent pressure and stretching applied to the circumferential edge 1012 as it is stretched down and into the opening 1010. The consistent pressure may assist in the creation of a substantially evenly stretched circumferential surface of the supplied film 1006 that is applied within opening 1010, thus providing a generally more consistently flat sealing surface at circumferential edge 1012 to which the circumferential edge 1002 of tubular body 1004 can be welded. That is, such automatic or semi-automatic means, may result in reduced or eliminated wrinkles on the liner weld surface where the circumferential edge 1012 meets circumferential edge 1002. Additionally, the use of such automatic or semi-automatic means can assist in the creation of more consistently sized and shaped liners than if the stretching were done manually by hand.

As with embodiments described above, the stretch tension of the supplied film 1006 at or near the circumferential edge 1012 can be measured and may be identified and set as a stretching endpoint determinate for any given liner embodiment, and in some cases, may also be a function of the film type/composition, the number of film layers, the thickness of the film, or other film characteristics. However, in other embodiments, a hard mechanical stop may be used to identify the amount of stretch the stretching apparatus may apply for any given liner embodiment. It is recognized, however, that any suitable method for determining an end stretching point for any given liner embodiment may be utilized.

With the circumferential edge 1012 of the supplied film 1006 stretched and positioned within opening 1010 of circumferentially expanded tubular body 1004, the circumferential edge 1012 of the supplied film may be appropriately aligned with circumferential edge 1002 of the tubular body. With the circumferential edge 1012 appropriately aligned with circumferential edge 1002, welding of the two circumferential edges 1012, 1002 may take place in a conventional manner, such as by a heat welding, utilizing one or more heat welding presses 1014 that traverse the exterior side of the circumferential edge 1002 of tubular body 1004 and thermally weld the two circumferential edges 1012, 1002 together along their respective lengths, as illustrated in the bottom picture in FIG. 10.

In general, the present disclosure describes a method of stretching, and in some embodiments, substantially evenly or uniformly stretching, a circumferential edge of a tubular structure, such that another material can be welded along the circumferential edge. The tubular structure need not have a circular cross-section, but could have any suitable cross-sectional configuration, including but not limited to, rectangular, square, oval, triangular, or any other regular or irregular shaped cross-section. Even more generally, the present disclosure describes a method of stretching, and in some embodiments, substantially evenly or uniformly stretching, along an edge or other section of a first film or material to be welded, such that another film or material (same or different) can be welded along the edge or other section. Stretching of the edge (or section) can be automated or semi-automated to help ensure more even and uniform stretching along the desired weld line or pattern and/or to help ensure more cleanly handling of the materials to be welded together.

After completion of welding the bottom 304 and top 306 portions to the body portion 302, or completion of any other suitable liner configuration, as just described, any excess material outside of the weld and not forming part of the liner itself may be trimmed, if desired. Trimming may be done after each welding step, or may be performed after all welding is completed. In still other embodiments, trimming may be done prior to welding, or even during welding, if desired.

With reference back to FIG. 4, subsequent step 408 where the bottom 304 and top 306 portions are welded to the body portion 302, the completed liner may be subjected to further manufacturing processes, such as but not limited to, labeling, folding, packaging, etc. Any other non-film components may be provided and included in such further manufacturing processes.

While only certain steps have been described as automated or semi-automated, it is recognized that any other additional steps could also, of course, be automated or semi-automated. For example, moving the tubular body portion 302 and sealing surface 608 to and from the stretching apparatus 800 may be done by automated or semi-automated means. Similarly, any transfers between a load/unload station 602 and the liner weld station 604 could also be done using automated or semi-automated means. Trimming of the excess material could likewise be performed utilizing automated or semi-automated means. Liner portion—e.g., body portion, top portion, bottom portion—formation and any substeps thereof, such as but not limited to cleaning or fitment fitting, could also be automated or semi-automated.

Methods of the present disclosure provide advantages over traditional manufacturing methods in clean production of the disclosed liner embodiments as the methods disclosed herein can significantly reduce or even substantially eliminate mechanical, including fixture contact, and human contact with wetted surfaces of the liners, which can be important depending on the intended contents for the liner. And, while described with respect to stretching of the circumferential edge of the tubular body portion, it is recognized that the bottom and top portions may additionally be stretched, as described above, utilizing the means for stabilizing, described above, to further assist in reducing or eliminating wrinkle formation in the desired sealing area of the liner. In still other embodiments, the circumferential edge of the tubular body portion need not be stretched, and could merely be laid over the sealing surface. In such embodiments, the bottom and top portions may nonetheless be stretched to help reduce wrinkle formation in the desired sealing area.

Three-dimensional, conformal liners of the present disclosure, including those particularly made by the methods disclosed herein, and/or the properties of the film comprising such liners (including the material used and/or the thickness of the liner) may advantageously provide the liners with desirable characteristics, including but not limited to: increased dispensability; reduction or elimination of fold gas, pinholes, and/or weld tears; and/or a reduction in the load and stress on the liner fitment. Various data has been obtained with respect to, and various tests have been performed on, such three-dimensional, conformal liners, which indicate significant, and even substantial, improvement over conventional liners. Appendix A includes various data and test results relating to such desirable characteristics, including but not limited to: increased dispensability; reduction or elimination of fold gas, pinholes, and/or weld strength. In Appendix A, three-dimensional, conformal liners of the present disclosure are referred to by several names, including “3D conformal,” “3DC,” “NS50,” “NS50 liner,” “NS50-3DC,” or the like, as will be readily recognized. In the various data and test results, liners of the present disclosure are compared to liners referred to as “N500,” which is a conventional two-dimensional, pillow-type liner.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A method for manufacturing a liner, the method comprising:
substantially uniformly stretching a tubular liner body near a circumferential edge; and
welding a sheet portion along the stretched circumferential edge.

2. The method of manufacturing a liner of claim 1, wherein the circumferential edge is a top circumferential edge of the tubular liner body, and wherein the sheet portion is a top liner sheet portion having a fitment welded thereto.

3. The method of manufacturing a liner of claim 2, further comprising substantially uniformly stretching the tubular body near a bottom circumferential edge and welding a bottom liner sheet portion along the stretched bottom circumferential edge.

4. The method of manufacturing a liner of claim 2, wherein the top liner sheet portion is welded to the tubular liner body such that the fitment of the top liner sheet portion is substantially aligned with a central axis of the tubular liner body.

5. The method of manufacturing a liner of claim 1, further comprising removably attaching the circumferential edge of the tubular liner body to a stretching apparatus and activating the stretching apparatus so as to radially stretch the circumferential edge.

6. The method of manufacturing a liner of claim 5, wherein the circumferential edge is stretched radially substantially equally along the circumferential edge.

7. The method of manufacturing a liner of claim 5, further comprising positioning the stretched circumferential edge over a sealing ring and detaching the circumferential edge from the stretching apparatus, thereby leaving the circumferential edge stretched over the sealing ring.

8. The method of manufacturing a liner of claim 7, further comprising positioning the sheet portion over the circumferential edge stretched over the sealing ring, and wherein welding the sheet portion along the stretched circumferential edge comprises welding the sheet portion to the stretched circumferential edge along the sealing ring.

9. The method of manufacturing a liner of claim 8, wherein positioning the sheet portion over the circumferential edge stretched over the sealing ring further comprises stretching the sheet portion in at least one direction.

10. The method of manufacturing a liner of claim 1, further comprising:
supporting the tubular liner body with the circumferential edge substantially stretched open;
supporting the sheet portion over the open circumferential edge, the plane of the sheet portion being substantially perpendicular to a central axis of the tubular liner body; and
activating a stretching apparatus to contact the sheet portion on a side opposite the tubular liner body and extend at least a portion of the sheet portion into the open circumferential edge.

11. The method of manufacturing a liner of claim 1, wherein the tubular liner body has a thickness of between about 80 microns and about 280 microns.

12. A method for manufacturing a liner, the method comprising:
forming a tubular body portion having a top circumferential edge, a bottom circumferential edge, and a weld seam extending from the top circumferential edge to the bottom circumferential edge;
stretching the tubular body near the top circumferential edge and welding a top liner sheet portion along the stretched top circumferential edge, the top liner sheet portion having a fitment welded thereto; and
stretching the tubular body near the bottom circumferential edge and welding a bottom liner sheet portion along the stretched bottom circumferential edge.

13. The method for manufacturing a liner of claim 12, wherein the weld between the tubular body portion and the top liner sheet portion is effected with wetted surfaces of each portion in contact.

14. The method for manufacturing a liner of claim 13, wherein the weld between the tubular body portion and the bottom liner sheet portion is effected with inner wetted surfaces of each portion in contact.

15. The method for manufacturing a liner of claim 12, wherein the tubular body portion comprises two sheets welded together to form a tubular body, the tubular body portion thus having two weld seams extending from the top circumferential edge to the bottom circumferential edge.

16. The method for manufacturing a liner of claim 15, further comprising:
removably attaching the top circumferential edge of the tubular liner body to a stretching apparatus, activating the stretching apparatus so as to radially stretch the top circumferential edge, positioning the stretched top circumferential edge over a sealing ring, detaching the top circumferential edge from the stretching apparatus, thereby leaving the top circumferential edge stretched over the sealing ring, and positioning the top liner sheet portion over the top circumferential edge stretched over the sealing ring for welding the top liner sheet portion along the top stretched circumferential edge; and
removably attaching the bottom circumferential edge of the tubular liner body to the stretching apparatus, activating the stretching apparatus so as to radially stretch the bottom circumferential edge, positioning the stretched bottom circumferential edge over the sealing ring, detaching the bottom circumferential edge from the stretching apparatus, thereby leaving the bottom circumferential edge stretched over the sealing ring, and positioning the bottom liner sheet portion over the bottom circumferential edge stretched over the sealing ring for welding the bottom liner sheet portion along the stretched bottom circumferential edge.

17. A liner made by the process of:
forming a tubular body portion having a top circumferential edge and a bottom circumferential edge and a vertical weld seam;
stretching the tubular body near the top circumferential edge and welding a top liner sheet portion along the stretched top circumferential edge, the top liner sheet portion having a fitment welded thereto; and
stretching the tubular body near the bottom circumferential edge and welding a bottom liner sheet portion along the stretched bottom circumferential edge.

18. The liner of claim 17, wherein the weld between the tubular body portion and the top liner sheet portion is effected with wetted surfaces of each portion in contact.

19. The liner of claim 18, wherein the weld between the tubular body portion and the bottom liner sheet portion is effected with inner wetted surfaces of each portion in contact.

20. The liner of claim 17, wherein the tubular body portion comprises two sheets welded together to form a tubular body, the tubular body portion thus having two weld seams extending from the top circumferential edge to the bottom circumferential edge.
